(19) United States
(12) Patent Application Publication
(10) Pub. No.: US 2007/0210748 A1
(43) Pub. Date: Sep. 13, 2007

(54) Power supply and electronic device having integrated power supply

(76) Inventors: Mark Unkrich, Emerald Hills, CA (US); Michael Frank, Menlo Park, CA (US); Richard C. Ruby, Menlo Park, CA (US)

Correspondence Address: Kathy Manke;Avago Technologies Limited, 4380 Ziegler Road, Fort Collins, CO, 80525, US

(21) Appl. No.: 11/371,761

(22) Filed: Mar. 9, 2006

(51) Int. Cl. H02J 7/00

(52) U.S. Cl. 320/114

(57) ABSTRACT

An integrated power supply, an integrated battery charger and a portable electronic device with an integrated power supply are described.

### CROSS-REFERENCE TO RELATED APPLICATIONS

The present application is related to commonly assigned U.S. patent application Ser. No. ______ (Avago Docket Number 10060064-1), entitled “AC-DC Power Converter” to Mark Unkrich and filed on even date herewith. The entire disclosure of this related application is specifically incorporated herein by reference.

### BACKGROUND

Portable electronic devices are ubiquitous in society. For example, electronic devices such as telephones, computers, radios and televisions have all evolved from stationary devices that connected to AC power in the home or office, to portable devices adapted to operate on direct current (DC) power that is normally connected directly to the device. Often, the DC power source is a battery that can be charged and recharged repeatedly for reuse. The ability to recharge the battery is both economically and environmentally beneficial.

Known methods of charging batteries of portable electronic devices include the use of a separate power supply that is connected at one end to an alternating current (AC) power and at the other end to the battery of the portable electronic device. The power supply converts the AC power to DC power and recharges the battery by providing DC current in a reverse direction to normal current flow of the battery.

As noted, known power supplies used to provide DC power to a portable electronic device for powering the device, or charging its battery(s), or both, are separate from the device and must be carried by the user or maintained in a location for use. Moreover, known power supplies are rather bulky, often rivaling, if not exceeding the size of the portable device itself. As can be appreciated, the noted characteristics of known power supplies render them rather inconvenient to use.

What is needed, therefore, is a power supply that overcomes at least the shortcomings of known power supplies described above.

### SUMMARY

In accordance with an example embodiment, a portable electronic device includes an integrated battery charger adapted to convert a source of alternating current (AC) power to a direct current (DC) power. The integrated battery charger further includes an acoustic isolation transformer.

In accordance with another example embodiment, an integrated power supply includes a battery and an integrated battery charger connected to the battery and adapted to convert a source of alternating current (AC) power to a direct current (DC) power. The integrated battery charger further includes an acoustic isolation transformer.

In accordance with another example embodiment, a multi-chip module includes a substrate and an integrated battery charger having components disposed in the substrate or over a surface of the substrate, or both, and adapted to convert a source of alternating current (AC) power to a direct current (DC) power. The integrated battery charger further includes an acoustic isolation transformer.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1A is a perspective view of a portable electronic device including an integrated power supply in accordance with an example embodiment.

FIG. 1B is a perspective view of a portable electronic device including an integrated power supply in accordance with an example embodiment.

FIG. 2 is a perspective view of a portable device including an integrated power supply accordance with an example embodiment.

FIG. 3 is a simplified block diagram of an integrated power supply in accordance with an example embodiment.

FIG. 4 is a conceptual view of an integrated power supply in a multi-chip module (MCM) in accordance with another example embodiment.

### DEFINED TERMINOLOGY

The terms ‘a’ or ‘an’, as used herein are defined as one or more than one.

The term ‘plurality’ as used herein is defined as two or more than two.

The term ‘integrated’ is defined herein as made into a whole by bringing parts together; unified.

### DETAILED DESCRIPTION

In the following detailed description, for purposes of explanation and not limitation, specific details are set forth in order to provide a thorough understanding of example embodiments according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the example embodiments. Such methods and apparati are clearly within the scope of the present teachings.

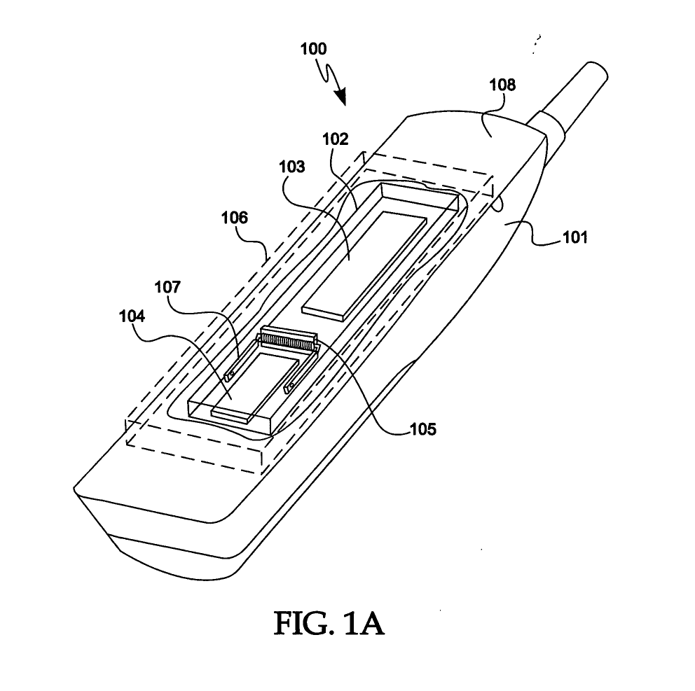

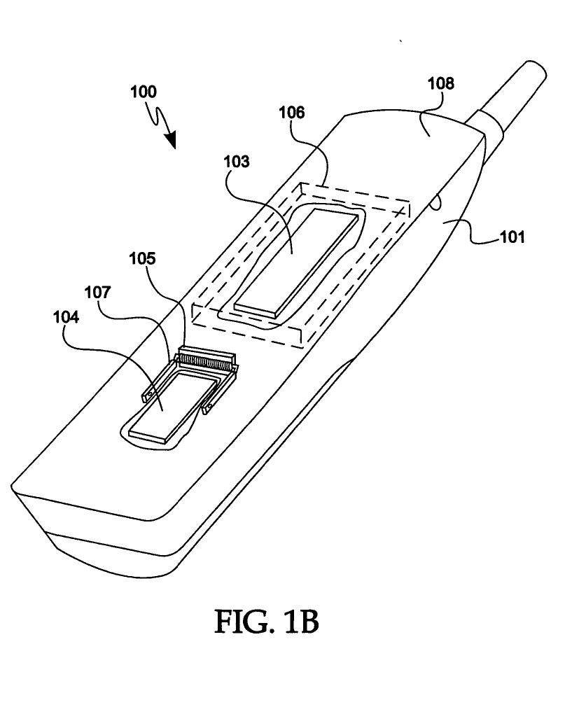

FIG. 1A is a perspective view in partial cut-away of an electronic device (device) 100 in accordance with an example embodiment. In the present view, the rear or back portion of the device 100 is shown. In certain embodiments, the device 100 is a mobile device and in other embodiments, the device 100 is a stationary device. Illustratively, the device 100 may be a mobile (cellular) telephone, a personal digital assistant (PDA), a portable computer, a portable video device, a portable music device, a portable radio transceiver, a pager, a digital camera, a video recorder, or a portable global positioning system (GPS) device.

The illustrative list of types of portable electronic devices of example embodiments is not intended to be in any way limiting of the application of the present teachings. Rather, the present teachings may be applied to a wide variety of electronic devices that are adapted to operate on DC power, or that includes a rechargeable battery, or both. Finally, and as will be readily apparent to one of ordinary skill in the art, many of the devices set forth in the illustrative list of devices can be incorporated into one portable electronic device. For example, the portable electronic device 100 may be a combined mobile phone, GPS device digital camera. Such portable electronic devices are contemplated by the present teachings.

The device 100 includes a housing 101 that includes germane electronic components as well as other required elements. For example, if the device 100 were a mobile phone, the housing 101 would include the transmit/receive electronics, a processor, a memory, a display and other components. As the various and sundry components required of each the illustrative devices noted above are known to those skilled in the art, details are omitted in order to avoid obscuring the description of the present embodiments.

The device 100 also includes an integrated power supply 102, which is shown as a transparent component for ease of description. Integrated into the power supply 102 is a battery 103 and a battery charger 104. The integrated power supply 102 also includes an electrical connector 105. The needed electrical connections between the electrical connector 105, the battery charger 104 and the battery 103 are made by one or more known methods.

In certain embodiments, a charging indicator is provided. The charging indicator may be an LED disposed on the integrated power supply 102, or on the device 100, or both. The charging indicator may be adapted to blink when charging is complete and to provide continuous output during charging, for example. In a specific embodiment, when the integrated power supply 102 is detached from the device and connected to an AC source, the charging indicator functions to indicate charging in-progress or charging completion.

Illustratively, the integrated power supply 102 is contained in the housing 101, or is disposed in a recess in the housing 101, and is enclosed by a cover 106, which connects to the housing 101. The battery charger 104, which is described more fully herein, is comparatively small and beneficially replaces known power supplies that are separate components and not integrated into the device 100.

In an example embodiment, the integrated power supply 102 is detachable from the device 100. In particular, the integrated power supply 102 is adapted to engage electrical contacts (not shown) of the device 100 and to be affixed to the device. Once affixed, the integrated power supply 102 is integrated into the device 100. Alternatively, the integrated power supply 102 may not be readily detachable from the device 100. In such an embodiment, the components of the integrated power supply 102 may be readily removed from the integrated power supply 102 allowing for service to or replacement of the components.

In the embodiment illustrated in FIG. 1A, the integrated power supply 102 is contained in the housing 101 or is disposed in a recess in the housing 101. In another embodiment, the integrated power supply 102 is disposed over a back surface 108 of the device 100, with the cover 106 disposed over the integrated power supply, or the surface 108, or both. Thus, in this embodiment, the integrated power supply is not ‘flush’ with the back surface 108 of the device 100. The integrated power supply 102 is adapted to engage the electrical contacts of the device 100 and to be affixed to the device 100.

In an embodiment, the electrical connector 105 is a prong-type connector adapted to engage a standard AC wall socket. While a two prong connector is shown, a three prong connector is contemplated. For example, the electrical connector 105 may be a two prong flat blade type connector, which is common in the United States, or a two round prong type connector common in Europe. Moreover, a known spacing-saving collapsible prong connectors are also contemplated.

The electrical connector 105 is adapted to rotate from the position shown so that in another position, prongs 107 of the connector 105 are substantially perpendicular to the back surface 108 of the device 100. In an embodiment, the cover 106 is removed providing access to the connector 105 to allow rotation of the connector 105. After being rotated into position, the prongs 107 may engage the wall outlet. This allows the front surface of the device 100, which is opposite surface 108, to be viewed. After the connection is made to the AC source, the integrated power supply 104 charges the battery 103.

In an alternative embodiment, the connector 105 is accessed without removing the cover 106. Illustratively, the connector 105 would not be recessed in the housing as shown, but rather would be disposed over the surface 108. The connector 105 would then be accessed through recesses or openings in the cover 106. The connector 105 would be rotated for engaging the wall outlet as described above.

In yet another embodiment, the cover 106 is substantially flush with the surface 108. The electrical connector 105 would be accessible through the cover 106 for rotation and engagement. Notably, the cover 106 may be the cover for the rear surface 108 of the device 100. It is emphasized that the noted embodiments are merely illustrative and other embodiments in keeping with the present teachings are contemplated.

Beneficially, the integrated power supply 102 of the example embodiments allows for the charging of the battery 103 by the integrated battery charger 104 of the device 100 merely by plugging the connector 105 into an AC power source. As described more fully herein, the integrated power supply 102 includes comparatively small components, which fosters the integration of the power supply 102 into the device 100.

FIG. 1B is a perspective view in partial cut-away of the portable electronic device 100 in accordance with an example embodiment. The embodiments described presently share many common features with embodiments described in connection with FIG. 1A. Such common features are generally not repeated to avoid obscuring the presently described embodiments.

In an example embodiment, the battery charger 104 and the battery 103 are not an integrated component, such as integrated power supply 102. However, the battery charger 104 and the electrical connector 105 are individual components integrated into the device 100. In an embodiment, the battery charger 104 is disposed in the housing 101 or is disposed in a recess in the housing 101. Likewise, the battery 103 is disposed in the housing 101, or is disposed in a recess in the housing 101. The electrical connector 105 may be provided in a recess in the housing 101 as described previously.

The cover 106 is adapted to fit over the battery 103 and may be either raised or flush with the surface 108. A separate cover (not shown) may be provided over the battery charger 104, for example if the battery charger were disposed in a recess and ready access to the charger was desired. Alternatively, the battery charger 104 may be accessed only by removal of the backing of the device 100.

In operation, the battery charger 104 charges the battery 103 from an AC power source, such as a wall socket. However, as will be apparent to one of ordinary skill in the art, the battery charger 104 may function as a power supply, which provides DC power to the device 100 from an AC source, and may be referred to herein as such. Regardless, the battery charger 104 is comparatively small in volume and is integrated into the device 100.

Beneficially, the integration of the battery charger 104 into the device 100 according to the example embodiments allows the user to charge the battery 103, or operate the device 100, or both, without the need of an external battery charger.

As described more fully herein, the battery charger 104 is substantially smaller than known chargers, thereby fostering its integration with the portable electronic device 100. Nonetheless, the battery charger 104 provides comparable electrical power to that supplied by known separate or external battery chargers. Thus, the integrated battery charger 104 provides substantially the same function as known external battery chargers, but is integrated with the device 100 affording significant convenience to the user.

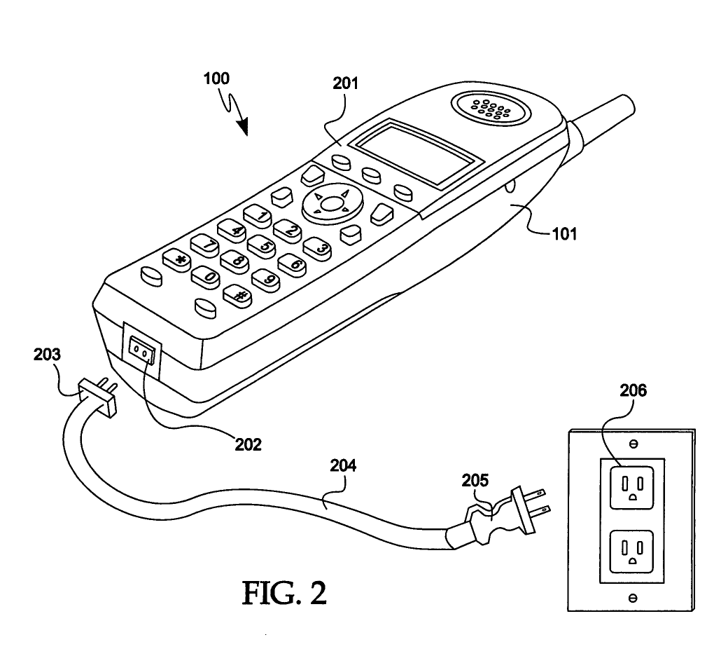

FIG. 2 is a conceptual view of the portable electronic device 100 in accordance with yet another example embodiment and with a front surface 201 shown. The device 100 shares many common features with the embodiments described in connection with FIGS. 1A and 1B. The descriptions of these common features are not repeated in order to avoid obscuring the description of the present embodiment. Notably, the integrated battery charger 104, or the integrated power supply 102 may be incorporated into the device 100. However, the prong-type electrical connector 105 is not necessarily included in the present embodiment.

In the embodiment shown, the device 100 is a mobile phone. It is emphasized that this is merely illustrative and that the present teachings contemplate other portable electronic devices, such those referenced previously. As is known, portable electronic devices may include one of a variety of electrical connectors that attach to an external battery charger. There are various reasons for the use of such connectors.

The present embodiment includes an electrical connector 202 that is other than a prong-type connector. The connector 202 is connected to a complementary (female or male) connector 203 that is connected to a cable 204. At the opposing end of the cable 204, a prong-style 205 connector is attached. The prong-style connector 205 engages a wall socket 206. AC power from the wall socket 206 is provided to the device 100 via the connectors 205, 203, 202. The connector 202 is connected to the battery charger 104, which charges the battery 103, or supplies DC power to the device 100, or both in a manner described in connection with the embodiments of FIGS. 1A and 1B.

In another embodiment, the use of the cable 204 is foregone. In particular, the complementary connector 203 is part of the prong-style connector 205, thus forming an adaptor. The electrical connector 202 and its complementary connector 203 may be one of a variety of electrical connectors used in portable electronic devices. The selected connectors depend on the type of device 100 and are known to those of ordinary skill in the art.

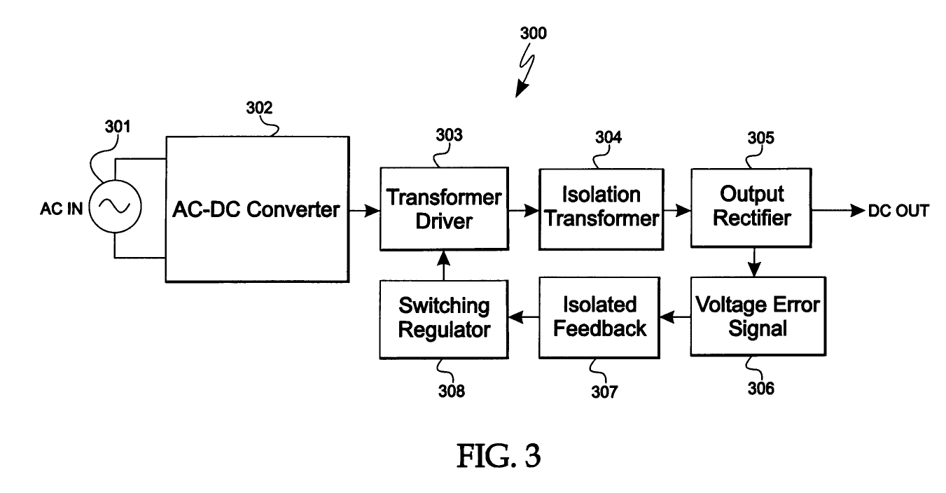

FIG. 3 is a simplified block diagram of a power supply 300 in accordance with an example embodiment. The power supply 300 may be the integrated battery charger 104 described previously.

An AC power source 301 (e.g., AC power from a wall outlet) is connected to an AC-DC converter 302. The connection may be made using the connector 105, or other connectors described previously. The AC-DC converter 302 may be based on one of a variety of rectification circuit architectures. For example, the AC-DC converter 302 may include a full wave diode bridge rectifier circuit.

In an example embodiment, in order to reduce the size of the capacitor holding the rectified charge following the full wave diode bridge rectifier circuit in the AC-DC converter 302 and at comparatively higher output power levels, a circuit as described in the incorporated patent application serial number (Avago 10060064-1) to Unkrich may be implemented. As described more fully in the referenced application, one or more capacitors having a comparatively small capacitance are provided in the circuit. The capacitors are required to hold the charge for a relatively short period of time, thereby allowing small capacitance and therefore, dimensionally comparatively small capacitors to be used.

The output of the AC-DC converter 302 is a rectified voltage. The output voltage from the converter 302 is applied to a transformer driver 303. The transformer driver 303 may be one of a number of driver circuits, including Class E or Class F driver circuits and variations thereof, full bridge driver circuits and half-bridge driver circuits. Illustratively, the transformer driver 303 may be a surface mount packaged die.

The transformer driver 303 is connected to a switching regulator 308. The transformer driver 303 typically includes one or more field effect transistor (FET) switches depending on the type of driver implemented. For example, a Class E driver includes one switch, a half-bridge driver includes two switches and the full-bridge circuit includes four switches for a differential input isolation transformer 304. The switches are turned on or off by the switching regulator 308. The output of the transformer driver 303 is input to an isolation transformer 304.

Typically, the switches of the transformer driver 303 connect the inputs of the isolation transformer 304 alternately to a comparatively high DC voltage level, system ground, or open circuit depending upon the regulator architecture and transformer requirements. Typically, the driver circuits include components in addition to the FET switches. These components often include passive components and are used to meet certain criteria for high efficiency driving. Architectures with the drivers mentioned above may be designed to meet Zero Voltage Switching (ZVS) switching conditions, for example. The additional components for the driver circuits and architectures to meet ZVS switching conditions are known to one of ordinary skill in the art.

In example embodiments, the isolation transformer 304 is an acoustic (mechanical wave) transformer that includes piezoelectric material. In certain embodiments, the isolation transformer 304 is a bulk acoustic wave transformer. The isolation transformer 304 may be an acoustically coupled transformer.

In one or more illustrative embodiments the isolation transformer 304 may be an acoustic isolation transformer, such as described in representative U.S. Pat. Nos.: 6,954,121, 6,946,928, 6,927,651, 6,874,212, 6,874,211, 6,787,048, 6,668,618, 6,651,488, 6,617,249, 6,566,979, 6,550,664, 6,542,055, 6,483,229, 6,472,954, 6,469,597, 6,424,237, 6,420,820, 6,262,637, 6,215,375; and U.S. patent Publication 20050128030A1 to Larson et al. Furthermore, in an embodiment, the isolation transducer 304 can include a resonant structure as described in U.S. Pat. No. 5,587,620 to Ruby, et al. The disclosures of the representative patents and patent publication are specifically incorporated herein by reference. It is emphasized that the teachings of the above-incorporated patents and publication are illustrative and that other acoustic isolation transformers are contemplated by the present teachings.

In general, the isolation transformer 304 of the representative embodiment comprises an acoustic piezoelectric transducer, an electrical isolation barrier, and another acoustic piezoelectric transducer. Representative piezoelectric materials include, but are not limited to, aluminum nitride (AlN), zinc oxide (ZnO) or lead zirconium titanate (PZT). Structures based on the latter are known to operate efficiently at lower frequencies.

The frequency response of the acoustic transformer is set by the velocity of sound in the material and the thicknesses of the material. Depending upon the coupling mode, different dimensions are relevant. For the longitudinal mode of the acoustic transducer, the resonant frequency is a function, inter alia, of the thickness of the piezoelectric material and the thickness of metal electrodes used to drive the piezoelectric material. In a specific embodiment, the thickness of the layers of piezoelectric material and the electrodes are on the order of approximately 3.0 μm to approximately 20.0 μm. The volume of the isolation transformer 304 of a specific embodiment is in the range of approximately 1.0 mm³ to approximately 0.1 mm³.

As is known, the power per unit volume of a transformer is proportional to the resonance frequency of the transformer. Accordingly, the resonance frequency of the transformer increases with decreasing transformer size (volume or thickness in the case of the longitudinal mode resonance of the acoustic transformer) at a prescribed power level. Stated differently, by driving the isolation transformer 304 at a higher frequency, a desired output electrical power can be attained for a comparatively dimensionally smaller transformer. As such, the transformer 304 is small enough to foster integration of the power supply 300 into a portable electronic device. By contrast, transformers of known power supplies are comparatively large.

In example embodiments incorporating an acoustic transformer having dimensions described, the operational frequencies of the isolation transformer 304 are in the range of approximately 50.0 MHz to approximately 300.0 MHz with an output power of on the order of approximately 1.0 W to approximately 5.0 W. Notably, the acoustic transformer 304 may be fabricated to function at frequencies as low as approximately 10 MHz and frequencies on the order of 109 Hz. It is emphasized that the noted characteristics of the isolation transformer 304 are merely illustrative. For example, the power supplies of the example embodiments may be used in parallel or designed for higher or lower power output.

The output of the isolation transformer 304 is input to an output rectifier 305, which provides the DC output voltage to the portable electronic device or battery, or both. The output rectifier 305 may be one of a number of known circuits useful rectifying an output signal from a transformer. Beneficially, the output rectifier 305 is fashioned in a dimensionally small structure or package. For example, the output rectifier 305 may be a diode bridge full wave rectifier in a single die.

The power supply 300 includes a feedback loop useful in regulating the DC output voltage. The feedback loop compares the DC output voltage with a reference voltage, which is preset or programmatically controlled to the desired output. This generates a voltage error signal that the feedback loop compensates by adjusting the modulation control generated by the switching regulator 308. Commonly used modulation techniques in AC-DC power converters include frequency modulation, phase modulation and pulse width modulation. For example, there is a switching frequency at which the output voltage of the transformer is a relative maximum. Therefore adjusting the switching frequency from this level can reduce the output voltage or the power transferred through the transformer to regulate and maintain the DC output voltage.

The feedback loop is described presently. Many of the components of the loop and their function are known to one of ordinary skill in the art. As such, many details of the components are omitted in order to avoid obscuring the description of the present embodiments.

The loop includes a voltage error signal circuit 306 that taps the DC output signal from the output rectifier 305. In a typical embodiment, the voltage error signal circuit 306 is a known resistor/diode circuit that may be an integrated circuit, surface mount components, packaged die or a combination thereof. Moreover, passive components may also be thin film components or thick film components that are part of a substrate of the voltage error signal circuit 306.

A voltage error signal from the circuit 306 is provided to an isolated feedback circuit 307. In a specific embodiment, isolated feedback circuit 307 is a known optocoupler circuit that converts the input signal to an optical signal and then back to an electrical signal using photodiodes and photodetectors. In an alternative embodiment, the isolation feedback circuit 307 may be a known isolation transformer with signal modulation. For example an acoustic isolation transformer according to the teachings of one or more of the above-incorporated patents may be used. In either embodiment, the circuit can be a packaged die and provides suitable isolation of the voltage error signal circuit from the switching regulator 308.

The output of the isolation circuit is input to the switching regulator 308. The switching regulator 308 is a known control circuit that switches the transformer driver 303 rapidly typically between two states to drive power through the transformer. Modulation of the switching is part of the feedback control used to stabilize the DC output voltage from the power supply. In operation, the switching regulator 308 cycles the transformer driver input between a first voltage and a second voltage to provide a desired DC output voltage.

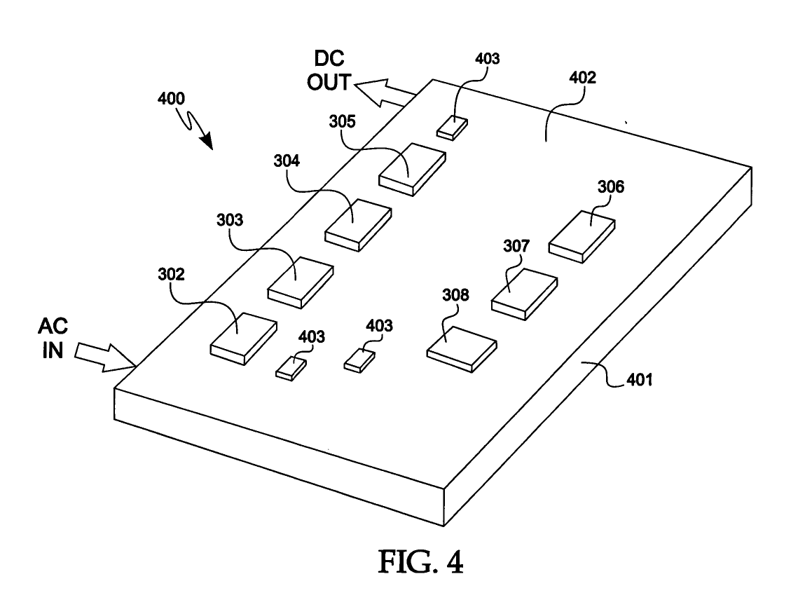

FIG. 4 is a conceptual view of a multi-chip module (MCM) 400 including a power supply in accordance with an example embodiment. The power supply includes many features common to those described in connection with FIG. 3. The details of these features are not repeated so as to avoid obscuring the description of the present embodiments.

The MCM 400 may include a plurality of unpackaged (bare) die, or a combination of packaged and unpackaged die, signal conditioning circuitry (not shown) and supporting circuitry (not shown) disposed over a substrate 401. The substrate 401 may be one of a plurality of materials useful in MCM applications. These include, but are not limited to PC board (e.g., FR4) and ceramic substrates as well as others known to those skilled in the art. The substrate may be processed to include connections such as circuits and vias by techniques known to those skilled in the art.

In embodiments, the components of the power supply 300 are provided as unpackaged die. To this end, the AC-DC converter 302; the transformer driver 303; the isolation transformer 304; the output regulator 305; the voltage error signal circuit 306; the isolated feedback circuit 307; and the switching regulator 308 may be packaged die, or unpackaged die. In certain embodiments, the packaging may include wafer scale packaging to include microcapping of the die. As is known, microcapping can provide surface mount components and comparatively small size and low cost components.

In a specific embodiment, the transformer driver 303 or the isolation transformer 304, or both, may be packaged surface mount components disposed over a surface 402. In addition, passive components 403, such as used for impedance matching and signal conditioning are provided in chip form. The passive components 403 may also be embedded in or constructed on the substrate 401. For example, the components 403 may be thick film or thin film components and laminate structures, to mention only a few possibilities. The passive components 403 include, for example, chip resistors and chip capacitors. In yet another alternative embodiment, the substrate and the components that comprise the power supply 300 may be overmolded, for example, over the surface 402 of the substrate 401.

The input AC signal is provided to the MCM 400 via contacts (not shown). Circuit traces (not shown) are fabricated by standard methods and provide the connections to and from the components of the MCM 400. Ultimately, the MCM 400 provides an output DC voltage.

Isolation is achieved by maintaining physical separation between the “input” side and the “output” sides of the circuit. For example, AC-DC converter 302; the transformer driver 303; and the switching regulator 308 are on one side and the output regulator 305 and the voltage error signal circuit 306 are on the other side. These components, circuit traces, and power and ground leads are respectively isolated for these two circuits as separate “halves” or regions of the substrate 401 in a corresponding fashion. The interconnect or interface between these two sections is comprised of the isolation transformer 304 and the isolation feedback circuit 307. As is known, these components have internal isolation. Similarly, the mounting and device connections, respectively connect to the corresponding isolated input and output portions of the AC-DC power converter.

The MCM 400 beneficially provides a circuit that is small compared to current discrete circuit implementations. Illustratively, the battery 103 may be disposed over the substrate 401 to provide the power supply module 102 described in connection with FIG. 1A. Alternatively, the MCM 400 may be integrated into a package that includes the battery 103. In particular, the MCM 400 provides the battery charger 104, or power supply described in connection with FIG. 1B. As will be readily appreciated, the MCM 400 fosters integration of the battery charger/power supply into a portable electronic device according to the present teachings. In another embodiment, the inclusion of an additional capacitor is contemplated. This capacitor may be useful for energy storage and filtering. The additional capacitor may not be part of the MCM 400 but able to connect to it and be incorporated in the module 102 or device 100. The additional capacitor may be beneficial in certain higher power applications.

In accordance with example embodiments, a power supply and a portable electronic device including an integrated power supply are described. Beneficially, the power supply includes components that are comparatively small in dimension but provide the requisite electrical performance by virtue of present teachings. One of ordinary skill in the art appreciates that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

1. A portable electronic device, comprising:
an integrated battery charger adapted to convert alternating current (AC) power from an AC power source to a direct current (DC) power, the integrated battery charger further comprising:
an acoustic isolation transformer.

2. A portable electronic device as recited in claim 1, wherein the acoustic isolation transformer includes a bulk acoustic resonator.

3. A portable electronic device as recited in claim 1, wherein the acoustic isolation transformer includes a stack of film piezoelectric material.

4. A portable electronic device as recited in claim 1, wherein the portable electronic device includes one or more of a mobile telephone; a personal digital assistant (PDA); a portable computer; a portable video device; a portable music device; a portable radio transceiver; a pager; or a digital camera; or a video recorder; or a portable global positioning system (GPS) device.

5. A portable electronic device as recited in claim 2, wherein the acoustic transformer further comprises lead zirconium titanate (PZT) piezoelectric material, or aluminum nitride (AlN) piezoelectric material, or zinc oxide (ZnO) piezoelectric material.

6. A portable electronic device as recited in claim 1, further comprising an integrated electrical connector adapted to connect the integrated power supply to the AC power source.

7. A portable electronic device as recited in claim 6, wherein the integrated electrical connector is a prong connector adapted to connect to a wall outlet.

8. A portable electronic device as recited in claim 6, wherein the integrated electrical connector is adapted to connect to a complementary connector, which is connected to a prong connector adapted to connect to a wall outlet.

9. A portable electronic device as recited in claim 1, further comprising an integrated power supply, which comprises the integrated battery charger and a battery.

10. A portable electronic device as recited in claim 1, wherein the battery charger is a multi-chip module.

11. A portable electronic device as recited in claim 9, wherein the integrated power supply is a multichip module.

12. An integrated power supply, comprising:
a battery;
an integrated battery charger connected to the battery and adapted to convert a source of alternating current (AC) power to a direct current (DC) power, the integrated battery charger further comprising:
an acoustic isolation transformer.

13. An integrated power supply as recited in claim 12, wherein the acoustic isolation transformer includes a bulk acoustic resonator.

14. An integrated power supply as recited in claim 12, wherein the acoustic isolation transformer includes a stack of film piezoelectric material.

15. An integrated power supply as recited in claim 12, further comprising a charging indicator.

16. An integrated power supply as recited in claim 12, further comprising an integrated electrical connector adapted to connect the integrated battery charger to the AC source.

17. An integrated power supply as recited in claim 12, wherein the integrated electrical connector is a prong connector adapted to connect to a wall outlet.

18. An integrated power supply as recited in claim 12, wherein the power supply is a multi-chip module (MCM).

19. An integrated power supply as recited in claim 12, wherein the acoustic transformer further comprises lead zirconium titanate (PZT) piezoelectric material, or aluminum nitride (AlN) piezoelectric material, or zinc oxide (ZnO) piezoelectric material.

20. A multi-chip module (MCM), comprising:
a substrate; and
an integrated battery charger having components disposed in the substrate or over a surface of the substrate, or both, and adapted to convert a source of alternating current (AC) power to a direct current (DC) power, the integrated battery charger further comprising:
an acoustic isolation transformer.

21. An MCM as recited in claim 20, wherein the acoustic isolation transformer includes a bulk acoustic resonator.

22. An MCM as recited in claim 20, wherein the acoustic isolation transformer includes a stack of film piezoelectric material.

23. An MCM as recited in claim 20, further comprising a charging indicator.

24. An MCM as recited in claim 20, wherein the acoustic transformer further comprises lead zirconium titanate (PZT) piezoelectric material, or aluminum nitride (AlN) piezoelectric material, or zinc oxide (ZnO) piezoelectric material.
